(19) United States
(12) Patent Application Publication
(10) Pub. No.: US 2008/0117385 A1
(43) Pub. Date: May 22, 2008

(54) LIQUID CRYSTAL DEVICE AND PROJECTOR HAVING THE SAME

(75) Inventor: Takashi ENDO, Shioliri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/684,857

(22) Filed: Mar. 12, 2007

(30) Foreign Application Priority Data
Mar. 13, 2006 (JP) 2006-067637

(51) Int. Cl. G03B 21/14

(52) U.S. Cl. 353/20

(57) ABSTRACT

A liquid crystal device includes: a liquid crystal cell which includes liquid crystals operating in a vertical alignment mode, in which optic axes of the liquid crystals are inclined and oriented at a predetermined pre-tilt angle with respect to a normal line to an incident surface in an off-state; an optical compensator having an optic axis in a direction inclined with respect to the surface, that is, an orientation direction of the liquid crystals of the liquid crystal cell in an off-state.

### TECHNICAL FIELD

The present invention relates to an image forming liquid crystal device, and more particularly, to a projector having the liquid crystal device.

### BACKGROUND ART

In the past, an optical compensation sheet having an optically anisotropic layer has been widely known as an optical compensation sheet suitable for a vertical orientation type liquid crystal panel as disclosed in Patent Document 1. The optically anisotropic layer includes a discotic compound of which tilt angles gradually changes with respect to the alignment film in order to compensate for retardation caused by a pre-tilt angle near the alignment film. Such a liquid crystal panel includes a negative uniaxial light-transmissive support or an optical compensation sheet of which an optical axis is arranged in a thickness direction of a liquid crystal cell in addition to an optical anisotropic layer in order to prevent leaking light generated when a vertically aligned liquid crystal cell is viewed askew with no voltage applied.

### Patent Document 1: JP-A-10-312166

### DISCLOSURE OF THE INVENTION

### Problem that the Invention is to Solve

Unfortunately, such an optical compensation sheet cannot efficiently prevent leaking light generated in a front direction of the liquid crystal cell with no voltage applied. That is, an actual liquid crystal cell has a pre-tilt angle in a predetermined direction with no voltage applied, and a viewing angle is shifted as much as the pre-tilt angle. As a result, relatively large amount of leaking light is generated within a target angle range with respect to a front direction of the liquid crystal cell during a light-shielding state in which no voltage is applied to the liquid crystal cell. Accordingly, the amount of transmitted light in a black image increases, and contrast of an image is degraded.

Since the aforementioned optical compensation sheet is formed of an organic material, a long time use may cause discoloration, and quality of the projected image may be degraded when the optical compensation sheet is used in a liquid crystal projector in which illumination light intensity should be high.

An advantage of some aspects of the invention is to provide a liquid crystal device in which image contrast degradation caused by an increasing amount of transmitted light in a black image which occurs in a front direction of a liquid crystal cell in a light-shielding state can be prevented, and a projector having the same.

Also, another advantage of some aspects of the invention is to provide a liquid crystal device in which image quality is seldom degraded even by a long time use as well as contrast degradation can be prevented and a projector having the same.

### Means for Solving the Problem

According to an aspect of the invention, there is provided a liquid crystal device comprising: (a) a liquid crystal cell which includes liquid crystals operating in a vertical alignment mode, in which optic axes of the liquid crystals are inclined and oriented at a predetermined pre-tilt angle with respect to a normal line to an incident surface in an off-state in which no voltage is applied to the liquid crystal cell; and (b) an optical compensator having an optic axis in a direction inclined with respect to the incident surface as an orientation direction of the liquid crystals in an off-state. Here, the orientation direction in an off-state means a major axis direction when a index ellipsoid of the liquid crystal is projected on the incident surface of the liquid crystal cell with no voltage applied to the liquid cell, and is set as a certain direction with respect to the incident surface of the liquid crystal cell.

In the liquid crystal device, the optic axes of the liquid crystals of a vertical alignment type liquid crystal cell in an off-state (i.e., with no voltage applied) are oriented to be inclined with respect to a normal line of the incident surface, and the liquid crystals have a so called pre-tilt. Since the optical compensator has an optic axis paralleled with the orientation direction of the liquid crystal in an off-state, and inclined with respect to the incident surface, the retardation of the imaging light in the front direction, generated by the pre-tilt of the vertical alignment type liquid crystal can be reduced by a birefringence characteristic of the optical compensator which compensates for the retardation. As a result, it is possible to prevent image contrast degradation caused by an increasing amount of transmitted light in a black image which occurs in a front direction of a liquid crystal cell in an off-state in which no voltage is applied to the liquid crystal cell. Furthermore, the fact that the optical compensator has the optic axis inclined at the same angle means that the pre-tilt angles remained in the vertical alignment type liquid crystals in an off-state can be parallelized, and retardation caused by the pre-tilt can be compensated for using the optical compensator having the optic axis inclined at the same angle.

In another aspect of the invention, the optic axis of the optical compensator of the liquid crystal device may be inclined at a predetermined angle corresponding to the predetermined pre-tilt angle of the liquid crystals in an off-state with respect to an optical path of a light beam incident in a normal direction to the incident surface of the liquid crystal cell. In this case, the retardation of the imaging light generated in a front direction by the pre-tilt of the liquid crystal can be compensated for by a birefringence characteristic of the optical compensator.

In another aspect of the invention, the optical compensator may include a flat element having an incident flat surface and an emitting flat surface paralleled with the incident surface of the liquid crystal cell. The flat element may have an optic axis inclined with respect to a normal line of the incident flat surface and the emitting flat surface. In this case, the optical compensator can be easily attached to the liquid crystal cell, and the optical compensator can be accurately and safely fixed to the liquid crystal cell and the like.

In another aspect of the invention, the optical compensator may include a flat element having an incident flat surface and an emitting flat surface paralleled with each other and an optic axis paralleled with a normal line of the incident flat surface and the emitting flat surface. The incident flat surface and the emitting flat surface may be inclined with respect to the incident surface of the liquid crystal cell. In this case, the optic axis of the optical compensator can be set to be perpendicular to the incident flat surface and the like. Therefore, a manufacturing process of the optical compensator can be relatively easy.

In another aspect of the invention, the optical compensator may have a pair of light-transmissive isotropic-members. Each one of the isotropic-members has a predetermined wedge angles. The isotropic-members provide an incident flat surface and an emitting flat surface paralleled with the incident surface of the liquid crystal cell by interposing the flat element therebetween. In this case, it is possible to simplify a manufacturing process of the optical compensator, and it is possible to accurately and safely fix the optical compensator to the liquid crystal cell or the like.

In another aspect of the invention, the optical compensator may have a thickness capable of substantially compensating for a retardation generated from the liquid crystals of the liquid crystal cell in an off-state. In this case, image contrast degradation caused by an increasing amount of transmitted light in a black image which occurs in a front direction of a liquid crystal cell due to the pre-tilt of the liquid crystal can be prevented by the optical compensator.

In another aspect of the invention, the optical compensator may be formed of negative uniaxial crystals. In this case, it is possible to compensate for retardation cased by the pre-tilt of the liquid crystal compound which is typically a positive uniaxial crystal. In the liquid crystal device having such a liquid crystal cell, image contrast degradation caused by an increasing amount of transmitted light in a black image can be prevented by the optical compensator. Furthermore, when the optical compensator is formed of inorganic crystals, light or thermal durability of the optical compensator can be improved, and the lifetime of the optical compensator can be increased.

In another aspect of the invention, the optical compensator may have a thickness capable of substantially compensating for a retardation generated from the liquid crystals in an off-state according to a range of inclination angle of illumination light with respect to the incident surface of the liquid crystal cell. In this case, it is possible to reduce the retardation in other adjacent directions as well as the front direction of the liquid crystal cell. Also, it is possible to improve quality of an image formed by the liquid crystal device.

According to another aspect of the invention, there is provided a projector comprising: (a) an optical modulator including the aforementioned liquid crystal device; (b) an illumination device which illuminates the optical modulator; and (c) a projection lens which projects an image formed by the optical modulator.

In the aforementioned projector, since the optical modulator including the aforementioned liquid crystal device is provided, image contrast degradation caused by an increasing amount of transmitted light in a black image which occurs in a front direction of a liquid crystal device in an off-state in which no voltage is applied to the liquid crystal cell can be prevented. Therefore, it is possible to provide a projector capable of projecting an image having high contrast using a simple method.

As described above, the liquid crystal device may be any one of the transmitting type or the reflective type. In case of the transmitting type, a pair of polarization elements are arranged to interpose the liquid crystal cell and the optical compensation element. In case of the reflective type, the optical compensation element is interposed between the polarization beam splitter and the liquid crystal cell. In the above construction, the polarization element or the polarization beam splitter may be formed of a transmitting or reflective type polarization element.

### BRIEF DESCRIPTION OF THE DRAWINGS

FIG. 1 is a side sectional view illustrating a liquid crystal light valve structure according to a first exemplary embodiment.

FIG. 2 is a side sectional view illustrating refractive indices of a liquid crystal layer and an optical compensator.

FIGS. 3A and 3B are side views illustrating a refractive index of a liquid crystal layer.

FIGS. 4A and 4B are side views illustrating a refractive index of an optical compensator.

FIGS. 5A and 5B illustrate dependence of a retardation on an inclination angle and a weight function of incident light.

FIG. 6 is a graph describing a result of simulation.

FIGS. 7A and 7B illustrate an example and a comparative example for a viewing angle in the simulation.

FIG. 8 is a side sectional view illustrating an optical compensator in a liquid crystal light valve according to the second exemplary embodiment.

FIG. 9 is a side sectional view illustrating an optical compensator included in a liquid crystal light valve according to the third exemplary embodiment.

FIG. 10 is a view illustrating an optical system of a projector including the liquid crystal light valve shown in FIG. 1.

FIG. 11 is a side sectional view illustrating a liquid crystal light valve according to a fifth exemplary embodiment.

FIG. 12 is a diagram illustrating an optical system of a projector having a liquid crystal light valve of FIG. 11.

### BEST MODE FOR CARRYING OUT THE INVENTION

### First Exemplary Embodiment

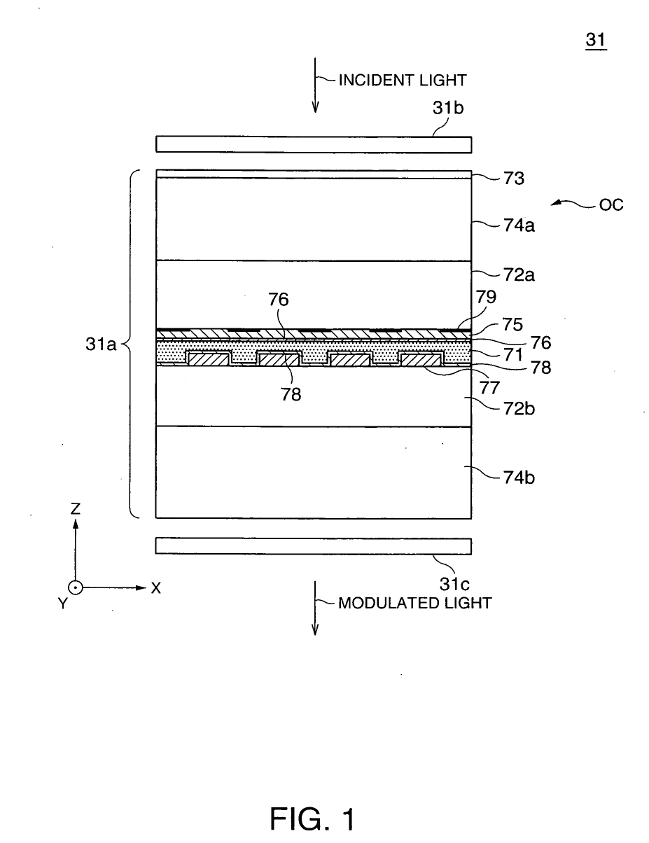

FIG. 1 is an enlarged cross-sectional view illustrating a structure of a liquid crystal light valve (i.e., an optical modulator) which is a liquid crystal device according to a first exemplary embodiment of the invention.

Referring to FIG. 1, a crystal liquid light valve 31 includes a cross nicol consisting of a first polarization filter 31b functioning as a polarization element in an incident side and a second polarization filter 31c functioning as a polarization element of an emitting side. A liquid crystal device 31a interposed between the first and second polarization filters 31b and 31c is a transparent type liquid crystal panel which changes a polarization direction of incident light on a pixel-by-pixel basis according to an input signal. The polarization filters 31b and 31c may be an absorption type polarizer formed of resin, and also, may be a reflection type polarizer such as a wire-grid polarizer.

The liquid crystal device 31a includes a first substrate 72a which is light-transmissive and disposed in an incident side, a second substrate 72b which is light-transmissive and disposed in an emitting side, and a liquid crystal layer 71 which is interposed therebetween and contains liquid crystals (i.e., a vertically oriented liquid crystal) operating in a vertical alignment mode. Furthermore, the liquid crystal device 31a includes an incident side cover 74a which covers an outer surface of the first substrate 72a which is light-transmissive and disposed in an incident side and an emitting side cover 74b which covers an outer surface of the second substrate 72b which is light-transmissive and disposed in an emitting side.

A transparent common electrode 75 is provided on a surface of the liquid crystal layer 71 side of the first substrate 72a, and, for example, an orientation film 76 is provided thereon. On the other hand, a plurality of transparent pixel electrodes 77 arranged in a matrix form and a thin film transistor (not shown) electrically connected to every transparent pixel electrode 77 are provided on a surface of the liquid crystal layer 71 side of the second substrate 72b, and, for example, an orientation film 78 is provided thereon. In this case, the first and second substrate 72a and 72b, the liquid crystal layer 71 interposed therebetween, and the electrodes 75 and 77 constitute a liquid crystal cell for changing a polarization state of incident light. In addition, each pixel of the liquid crystal cell includes a single pixel electrode 77, a common electrode 75, and a liquid crystal layer 71 interposed therebetween. Furthermore, a black matrix 79 which has a lattice structure for separating each pixel is provided between the first substrate 72a and the common electrode 75.

In this case, the orientation films 76 and 78 are provided to align liquid crystal compounds of the liquid crystal layer 71 in a desired orientation. The orientation films 76 and 78 orient optic axes of the liquid crystal compounds to be parallel with one another but slightly inclined with respect to a normal line of the first substrate 72a in an off-state where no voltage is applied to the liquid crystal layer 71. On the contrary, the orientation films 76 and 78 orient optic axes of the liquid crystal compounds to be perpendicular (e.g., an X-axis direction) to a normal line of the first substrate 72a in an on-state where a voltage is applied to the liquid crystal layer 71. As a result, it is possible to obtain a maximum light-shielding condition (i.e., a minimum luminance condition) in an off-state in which no voltage is applied to the liquid crystal layer 71. Also, it is possible to obtain a maximum transmitting condition (i.e., a maximum luminance condition) in an on-state in which a voltage is applied to the liquid crystal layer 71.

In addition, the liquid crystal device 31a includes a thin optical compensator 73 having a thickness lower than about 1 to 200 μm on an incident surface of the incident side cover 74a (i.e., a flat surface facing the first polarization filter 31b). The optical compensator 73 is attached to a flat surface of the incident side cover 74a using an optical adhesive to constitute an optical compensation element OC, and such a compound type optical compensation element OC is attached to the incident surface of the first substrate 72a using an optical adhesive. In addition, the optical compensation element OC may be formed of only an optical compensator 73. In this case, the incident side cover 74a is useless. Therefore, the optical compensator 73 may be directly attached to the first substrate 72a, or may be separated from the first substrate 72a and retained using an appropriate holder.

The optical compensator 73 is a flat element formed of light-transmissive negative uniaxial crystals of which a light incident surface is parallel with a light emitting surface. An optic axis of the optical compensator 73 is parallel with an X-Z plane including an orientation direction (i.e., an X-axis direction) of the liquid crystal layer 71, and also has a predetermined inclination to a Z-axis.

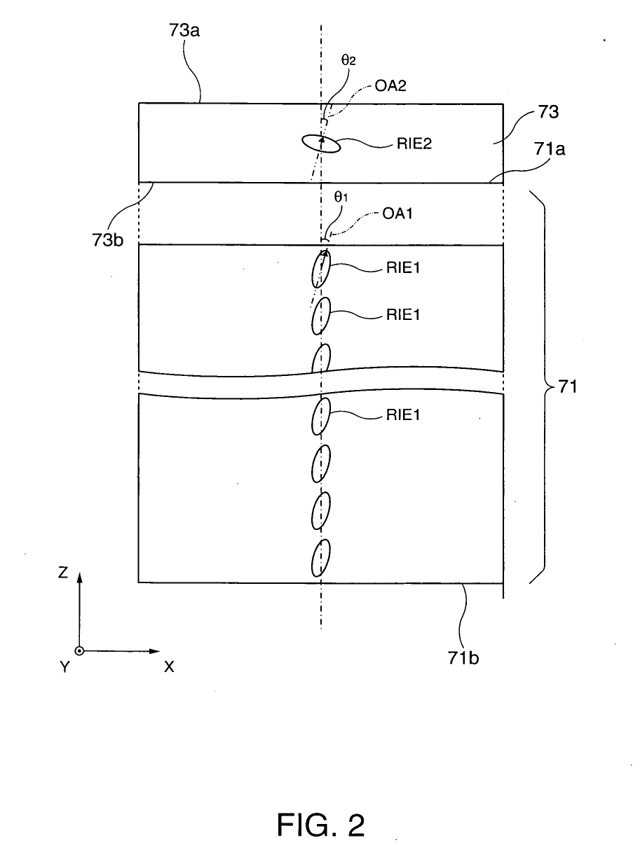

FIG. 2 is a side sectional view conceptually describing refractive indices of the liquid crystal layer 71 and the optical compensator 73. In FIG. 2, the incident and emitting surfaces 71a and 71b of the liquid crystal layer 71 and the incident and emitting flat surfaces 73a and 73b of the optical compensator 73 are parallel with one another.

In the liquid crystal layer 71, major axes (i.e., an optic axis OA1) of index ellipsoids RIE1 of liquid crystal compounds are slightly inclined to a Z-axis with a constant angle on the x-z plane. In this case, it is assumed that the major axis of the index ellipsoid RIE1 is inclined to an X-axis direction, which will be referred to as an orientation direction of the liquid crystal layer 71 hereinafter. In addition, the inclination angle of the index ellipsoid RIE1 in the orientation direction is referred to as a pre-tilt angle θ1. Meanwhile, in the optical compensator 73 minor axes (e.g., an optic axis OA2) of the index ellipsoids RIE2 of negative uniaxial crystals are on the X-Z plane and slightly inclined to the Z-axis with a constant angle. More specifically, the inclination direction (i.e., the azimuth angle) of the index ellipsoid RIE2 is parallel with the orientation direction (i.e., an X-axis direction) of the liquid crystal layer 71. The inclination angle θ2 (i.e., a polar angle) in the azimuth angle of the index ellipsoid RIE2 is approximately parallel with the pre-tilt angle θ1 of the liquid crystal layer 71 in this exemplary embodiment. The fact that the inclination angle θ2 of the minor axis of the index ellipsoid RIE2 in the optical compensator 73 is approximately parallel with the pre-tilt angle θ1 of the liquid crystal layer 71 means that the inclination angle θ2 of the minor axis of the index ellipsoid RIE in the optical compensator 73 is set by incrementing or decrementing the pre-tilt angle θ1 of the liquid crystal layer 71 in consideration with a difference of the refractive index (such that a light beam incident to the liquid crystal device 31a with a predetermined incident angle can be propagated in the optical compensator 73 in parallel with the light beam being propagating the liquid crystal layer 71) when the refractive index of the optical compensator 73 is not equal to that of the liquid crystal layer 71, while the inclination angle θ2 of the minor axis of the index ellipsoid RIE in the optical compensator 73 is parallel with the pre-tilt angle θ1 of the liquid crystal layer 71 when the refractive index of the optical compensator 73 is equal to that of the liquid crystal layer 71.

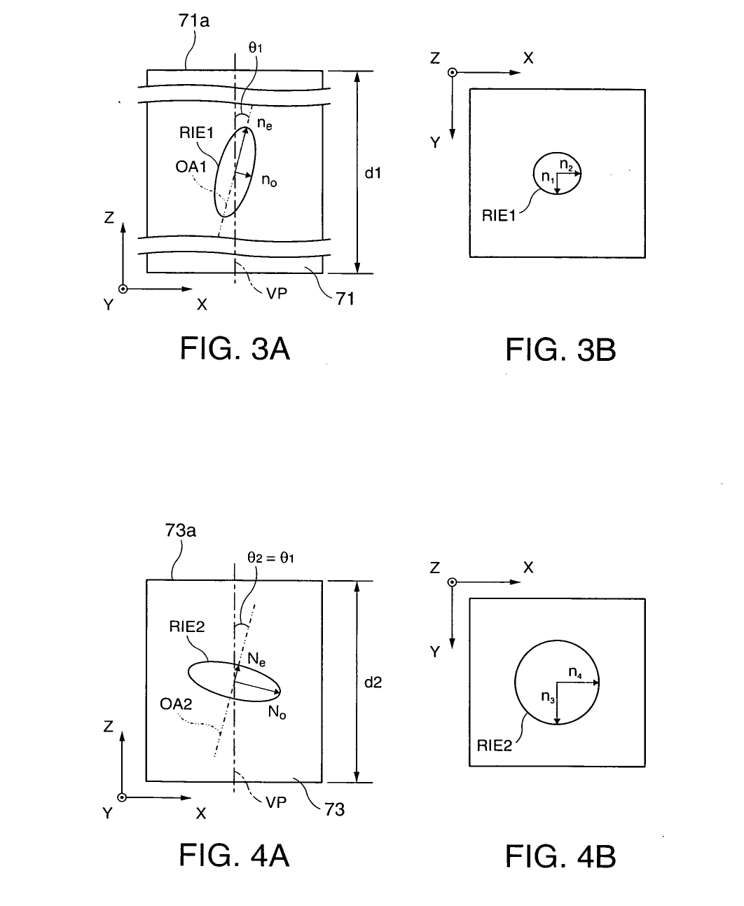

FIG. 3A is a side sectional view for describing a refractive index of a liquid crystal layer 71, and FIG. 3B is a plan view for describing a refractive index of the liquid crystal layer 71. In addition, FIG. 4A is a side sectional view for describing a refractive index of an optical compensator 73, and FIG. 4B is a plan view for describing a refractive index of an optical compensator 73.

First of all, paying attention to the liquid crystal layer 71, assuming that the index ellipsoid of the liquid crystal compounds corresponds to a positive uniaxial material, and axial components of the refractive index in each coordinate direction is denoted as nx, ny, and nz, a general relationship nx=ny<nz is obtained. Therefore, an optic axis OA1 corresponding to the major axis having a refractive index nz is inclined by a pre-tilt angle θ1 with respect to an optical path VP of a light beam (a perpendicularly incident light beam) incident in a normal direction perpendicularly to the incident surface 71a of the liquid crystal layer 71. In this case, assuming that no denotes an ordinary index, and nₑ denotes an extraordinary ordinary index, relationships nx=ny=nₒ and nz=nₑ are obtained as shown in FIG. 3A. As shown in FIG. 3B, assuming that the refractive index of the light beam vibrating in a slow axis direction of the perpendicularly incident light beam is denoted as n₂, and the refractive index of the light beam vibrating in an fast axis direction of the perpendicularly incident light beam is denoted as n₁, the following relationship can be obtained:

$$\begin{matrix}\text{[Formula 1]} & \\ {n}_{1} = {n}_{o} & ( 1 ) \\ {n}_{2} = \frac{{n}_{e} {n}_{o}}{\sqrt{{n}_{e}^{2} {cos}^{2} θ + {n}_{o}^{2} {sin}^{2} θ}} & ( 2 )\end{matrix}$$

Therefore, the retardation Re1 of the liquid crystal layer 71 for the perpendicularly incident light beam can be expressed as follows:

$$\begin{matrix}\text{[Formula 2]} & \\ \begin{matrix}Re 1 = ( {n}_{2} - {n}_{1} ) \times d 1 \\ = [ \frac{{n}_{e} {n}_{o}}{\sqrt{{n}_{e}^{2} {cos}^{2} θ + {n}_{o}^{2} {sin}^{2} θ}} - {n}_{o} ] \times d 1\end{matrix} & ( 3 )\end{matrix}$$

where d1 denotes a thickness of the liquid crystal layer 71. As described above, the optical compensator 73 is formed of negative uniaxial crystals, and generally has a relationship nx=ny>nz, where nx, ny, and nz denote axial components of the refractive index in each coordinate direction. Therefore, an optic axis OA2 corresponding to the minor axis having a refractive index nz is inclined by a inclination angle θ2=θ1 with respect to an optical path VP of a light beam (a perpendicularly incident light beam) incident in a normal direction perpendicularly to the incident flat surface 73a of the optical compensator 73. In this case, Nₒ denotes an ordinary index, and Nₑ denotes an extraordinary index as shown in FIG. 4A. As shown in FIG. 4B, assuming that the refractive index of the light beam vibrating in an fast axis direction of the perpendicularly incident light beam is denoted as n₄, and the refractive index of the light beam vibrating in an slow axis direction of the perpendicularly incident light beam is denoted as n₃, the following relationship can be obtained:

$$\begin{matrix}\text{[Formula 3]} & \\ {n}_{3} = {N}_{o} & ( 4 ) \\ {n}_{4} = \frac{{N}_{e} {N}_{o}}{\sqrt{{N}_{e}^{2} {cos}^{2} θ + {N}_{o}^{2} {sin}^{2} θ}} & ( 5 )\end{matrix}$$

Therefore, the retardation Re2 of the optical compensator 73 for the perpendicularly incident light beam can be expressed as follows:

$$\begin{matrix}\text{[Formula 4]} & \\ \begin{matrix}Re 2 = ( {n}_{3} - {n}_{4} ) \times d 2 \\ = [ {N}_{o} - \frac{{N}_{e} {N}_{o}}{\sqrt{{N}_{e}^{2} {cos}^{2} θ + {N}_{o}^{2} {sin}^{2} θ}} ] \times d 2\end{matrix} & ( 6 )\end{matrix}$$

where d2 denotes a thickness of the optical compensator 73. In this case, the major axis of the refractive index nz of the liquid crystal layer 71 is parallel with the minor axis of the refractive index nz of the optical compensator 73, and the slow axis and the fast axis are changed to each other. Therefore, a total retardation RE for the perpendicularly incident light beam is given by an absolute value of the difference between the value Re1 obtained by the formula (3) and the value Re2 obtained by the formula (6). In other words, if Re1=Re2, the polarized light emitted from the polarization filter 31b has the same state as the polarized light incident on the polarization filter 31c. Also, the light shielding in the polarization filter 31c for the perpendicularly incident light beam becomes perfect, and the image contrast determined by light-transmission and light-shielding in the liquid crystal light valve 31 becomes maximum.

Hereinafter, a case in which the light incident on the liquid crystal light valve 31 has an angle distribution will be described. First of all, a certain light flux L1 obliquely incident to the liquid crystal light valve 31 from the air will be considered. The inclination angle in the air is denoted as η0, the inclination angle in the optical compensator 73 is denoted as η1, and the inclination angle in the liquid crystal layer 71 is denoted as η2. In this case, in the optical compensator 73, since the difference between Nₒ and Nₑ is small, it can be assumed that Nₒ≈Nₑ. Therefore, the light flux incident on the optical compensator 73 from the air with the inclination angle η0 will be on an optical path satisfying the following conditions:

sin(η0):sin(η1)=1:1/Nₒ; and

sin(η1)=sin(η0)/Nₒ (7).

Furthermore, in the liquid crystal layer 71, since nₒ≈nₑ, the light flux incident on the liquid crystal layer 71 from the optical compensator 73 with the inclination angle η1 will be on an optical path satisfying the following conditions:

sin(η1):sin(η2)=1/Nₒ:1/nₒ; and

sin(η2)=sin(η1)(Nₒ/nₒ) (8).

In the aforementioned description, although the light flux incident on the incident surface 71a with the inclination angle η0 with respect to the normal line has been considered, the direction of inclination of the incident light is also important. Here, a direction of inclination with respect to the X-axis direction is considered by designating the inclination angle η0 as a polar angle and designating the azimuth angle of the incident light flux as φ. In this case, an angle w1 between the light flux passing through the liquid crystal light valve 31 and the optic axis OA1 in the optical compensator 73 and an angle w2 between the light flux passing through the liquid crystal light valve 31 and the optic axis OA2 in the liquid crystal layer 71 can be obtained in a geometrical manner on the basis of the variables η0 and φ, and η1 and T2 that can be obtained therefrom. The retardation Re′ generated when the obliquely incident light passes through the liquid crystal layer 71 and the optical compensator 73 can be obtained as follows:

$$\begin{matrix}\text{[Formula 5]} & \\ {Re}^{′} = [ {N}_{o} - \frac{{N}_{e} {N}_{o}}{\sqrt{{N}_{e}^{2} {cos}^{2} w 1 + {N}_{o}^{2} {sin}^{2} w 1}} ] \times \frac{d 2}{cos η 2} - [ \frac{{n}_{e} {n}_{o}}{\sqrt{{n}_{e}^{2} {cos}^{2} w 2 + {n}_{o}^{2} {sin}^{2} w 2}} - {n}_{e} ] \times \frac{d 1}{cos η 1} & ( 9 )\end{matrix}$$

In the above equation, d2/cos η2 denotes an effective optical path length of the obliquely incident light in the optical compensator 73, and d1/cos η1 denotes an effective optical path length of the obliquely incident light in the liquid crystal layer 71.

Finally, the retardation Re′ generated when the light passes through the liquid light valve 31 and the optical compensator 73 can be processed as follows:

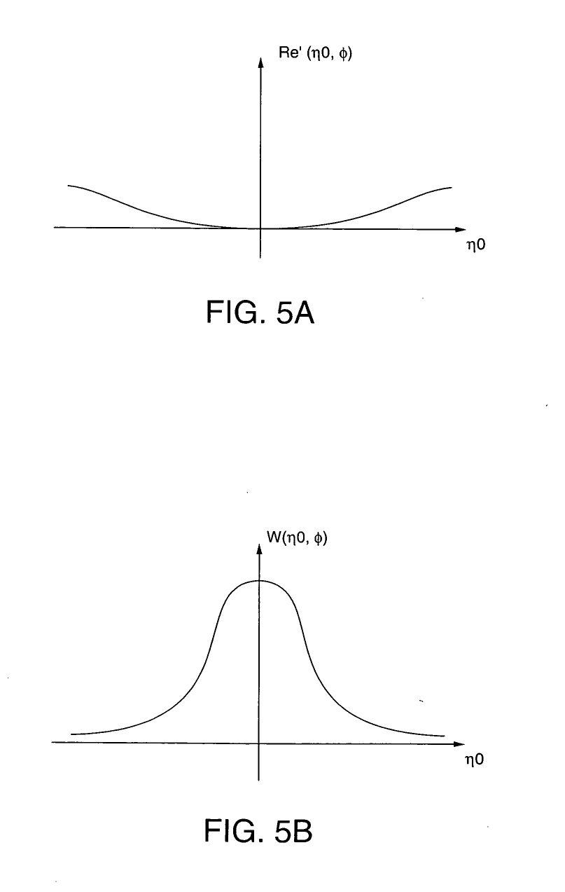

Re′=f(η0,φ) (10)

where, the refractive indices nₒ, nₑ, Nₒ, Nₑ, d1, and d2 are constants, and the values η1, η2, w1, and w2 are parameters determined by the aforementioned values η0 and φ. Therefore, the thickness d2 of the optical compensator 73 can be optimized so that a summation of the retardations Re′ for all incident light beams that are obtained on the basis of the above formula (10) becomes a minimum value. In this case, the image contrast determined by the light-transmission and the light-shielding of the liquid crystal light valve 31 becomes its maximum. For example, for the light flux perpendicularly incident on the liquid crystal light valve 31 with a constant numerical aperture NA, since the inclination angle η0 corresponding to the angular aperture becomes 0 to ηmax, and the azimuth angle φ becomes 0 to 360°, the optical compensator 73 is adjusted such that an integral value obtained by the following equation (11) approaches zero.

$$\begin{matrix}\text{[Formula 6]} & \\ {\int }_{0}^{η max} {\int }_{0}^{360} \vert f ( η0 , φ ) \times W ( η 0 , φ ) \vert d φ d η 0 & ( 11 )\end{matrix}$$

where, W(η0, φ) denotes a weight function given by an angle distribution of the incident light. FIG. 5A visually illustrates a relationship between the retardation Re′=f(η0, φ) of the passing light and the inclination angle η0 when the azimuth angle φ is deviating 90° from the direction of inclination. The retardation Re′becomes smallest for the light having the inclination angle η0 of zero. The retardation Re′ increases as the inclination angle η0 increases. In addition, FIG. 5B visually illustrates a relationship between the weight function W(η0, φ) of the incident light and the inclination angle η0. The light density in the front direction having an inclination angle η0 of zero becomes highest, and a weight function accordingly has a maximum value. The aforementioned description is just exemplary, and the characteristic of the retardation Re′=f(η0, φ) may be determined on the basis of optical characteristics of the liquid crystal layer 71 and the optical compensator 73, the weight function W(η0, φ) may be determined on the basis of a radiation characteristic of a light source, an optical characteristic of an integrator optical system, and a micro-lens characteristic of liquid crystals. That is, by adjusting the thickness d2 or the index ellipsoid RIE2 of the optical compensator 73, the integral value of the retardation Re′=f(η0, φ) can be minimized for various illumination devices having different weight functions W(η0, φ) as well as the image contrast provided by the liquid crystal light valve 31 can be maximized.

The integral value (a total retardation) represented by the formula (II) may be calculated using fast processing simulation. Also, the inclination angle θ2 or the thickness d2 of the optical compensator 73 can be immediately determined by inputting the characteristic of the liquid crystal layer 71 and the refractive index characteristic of the optical compensator 73.

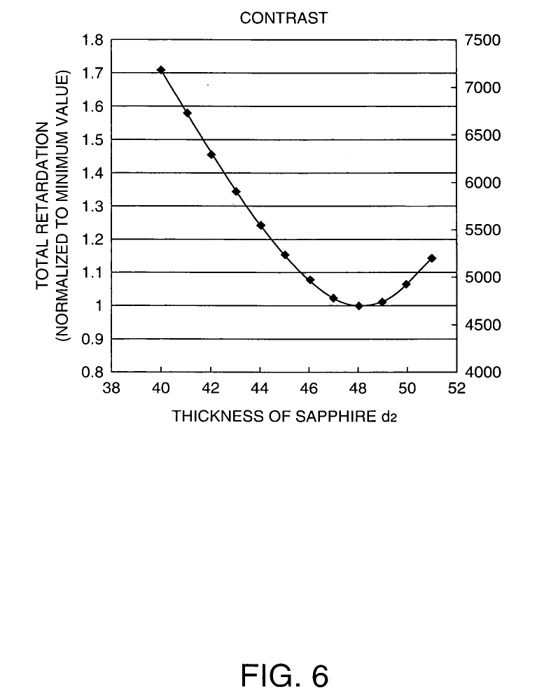

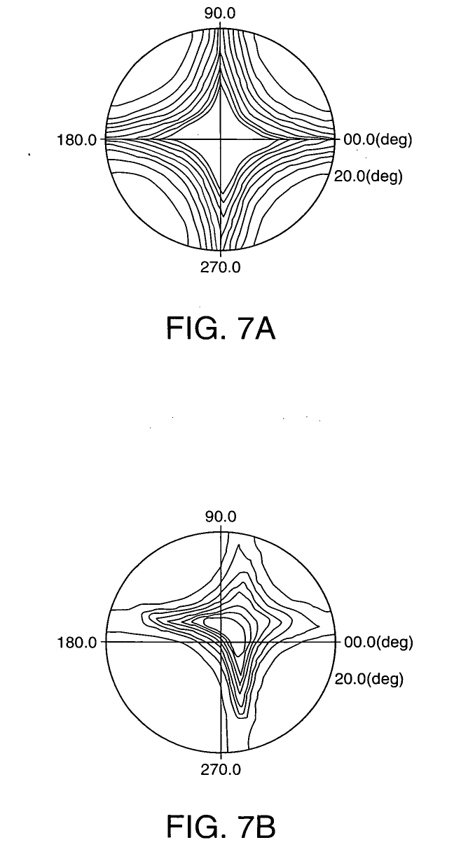

Specifically, as a detailed example, the optical compensator 73 for various liquid crystal layers 71 of the vertical alignment type have a thickness d2 ranged between 1 and 100 μm when sapphire crystals are used in the optical compensator 73. Particularly, as a result of simulation for the liquid crystal light valve 31 having a typical liquid crystal layer 71 of a vertical alignment type, the optimal thickness d2 of the optical compensator 73 was 48 μm when the integral value obtained in the formula (II) was minimized. Furthermore, the aforementioned simulation also revealed that 80% of the maximum contrast of the liquid crystal light valve 31 can be obtained by setting the thickness d2 to have a range of 48±6 μm. Results of the simulation are shown in FIG. 6, and data sheet thereof is shown in the following Table 1.

TABLE 1

| | sapphire thickness | | | | | |
|---|---|---|---|---|---|---|
| | 40 | 41 | 42 | 43 | 44 | 45 |
| total Re | 1297.205 | 1200.258 | 1108.547 | 1023.004 | 944.9827 | 876.3567 |
| normalized | 1.708655 | 1.580957 | 1.460157 | 1.347482 | 1.244714 | 1.154321 |
| Re | | | | | | |
| contrast | 5128.839 | 5501.8 | 5873.863 | 6226.838 | 6559.659 | 6832.757 |
| | sapphire thickness | | | | | |
| | 46 | 47 | 48 | 49 | 50 | 51 |
| total Re | 819.7412 | 778.9146 | 759.1969 | 767.5091 | 807.8016 | 858.6824 |
| normalized | 1.079748 | 1.025972 | 1 | 1.010949 | 1.064021 | 1.144212 |
| Re | | | | | | |
| contrast | 7061.382 | 7208.436 | 7280.668 | 7254.074 | 7141.832 | 6850.035 |

FIGS. 7A and 7B show results of simulation using detailed data of a liquid crystal light valve 31. FIG. 7A shows a viewing angle characteristic of a liquid crystal light valve 31 according to an exemplary embodiment, and FIG. 7B shows a viewing angle characteristic of a liquid crystal light valve according to a comparative example. The liquid crystal light valve of a comparative example does not have the optical compensator 73 in comparison with the liquid crystal light valve 31 of an exemplary embodiment. In both viewing angle characteristics, the contour line expresses the inclination angle with respect to a normal direction to the incident surface. It would be recognized from the drawing that the viewing angle characteristic of the liquid crystal light valve 31 of an exemplary embodiment is symmetrical with respect to the normal direction to the incident surface, and the contrast in a front direction of the liquid crystal light valve 31 is significantly improved.

Now, a method of manufacturing an optical compensation element OC having the optical compensator 73 will be described. First of all, an optical compensator 73 and an incident side cover 74a which are components of the optical compensation element OC are prepared. That is, sapphire as a material of the optical compensator 73 is cut out as thin as possible so that the inclination angle θ2 (i.e., the polar angle) and the direction of inclination (i.e., the azimuth angle) of the index ellipsoid RIE2 can be equal to those of the index ellipsoid RIE1 of the liquid crystal layer 71. Subsequently, a polishing process or the like is performed for a pair of opposite surfaces of the sapphire plate that has been cut out to smooth the surfaces. Then, a support plate is prepared using a material such as quartz and white glass, having high transmittance and no birefringence, to provide the incident side cover 74a. After a cleaning process, the sapphire plate is attached on the support plate via an ultraviolet (UV) curing resin, and then a curing process is performed to fix the sapphire plate. Subsequently, the sapphire plate attached on the support plate is polished using relatively harsh abrasive grains to allow the sapphire layer of the optical compensator 73 to have a thickness of 60 μm. In this case, when double surface polishing or the like is used, the thickness of the sapphire layer of the optical compensator 73 can be determined by measuring the retardation. When single surface polishing is used, the thickness of the sapphire layer of the optical compensator 73 can be determined using a micro-gauge. Since minute defects are formed on the polished surface, the defects are buried using an adhesive and the like having the same refractive index as that of the optical compensator 73. Otherwise, the surface of the optical compensator 73 is flattened by repeatedly polishing the surface using relatively smooth abrasive grains.

### Second Exemplary Embodiment

Hereinafter, a liquid crystal light valve (e.g., an optical modulator) will be described as a liquid crystal device according to the second exemplary embodiment of the invention. The liquid crystal light valve according to the second exemplary embodiment is obtained by modifying the liquid crystal light valve according to the first exemplary embodiment. Therefore, like elements denote like numerals as the first exemplary embodiment if they are not particularly described, and their detailed description will be omitted.

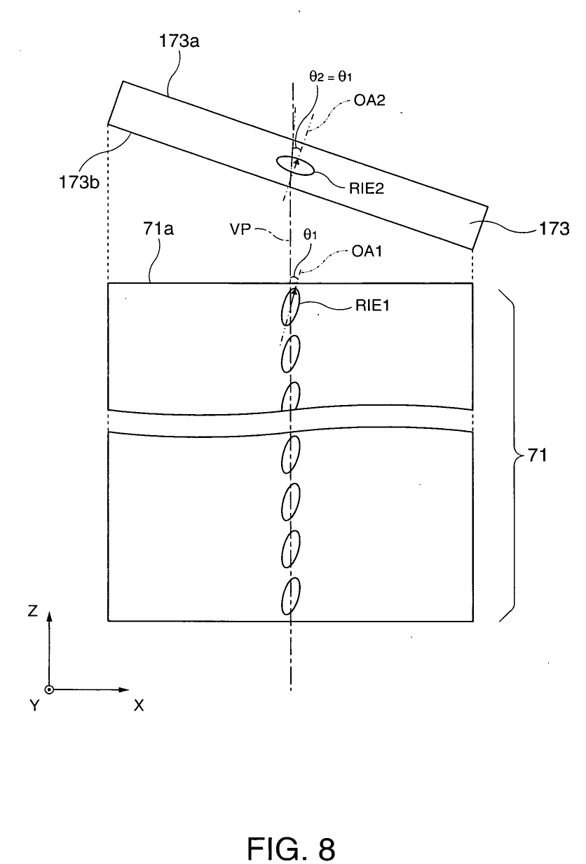

FIG. 8 is a side sectional view illustrating an optical compensator 173 inserted into a liquid crystal light valve according to the second exemplary embodiment. In this case, the optical compensator 173 is obliquely arranged with respect to the incident surface 71a of the liquid crystal layer 71. That is, the optical path VP of the light beam perpendicularly incident on the incident surface 71a of the liquid crystal layer 71 is inclined with respect to the incident flat surface 173a of the optical compensator 173 which is a flat element, and inclined with respect to the emitting flat surface 173b with the same inclination angle. In this case, although the optical compensator 173 is a flat element formed of negative transparent uniaxial crystals similarly to the first exemplary embodiment, the optical compensator 173 is fabricated such that the optic axis OA2 is perpendicular to the incident flat surface 173a in order to allow it to simply function as an optical compensator. In addition, the optical compensator 173 is fixed to a main body of the liquid crystal panels including the liquid crystal layer 71 and the like using a holder (not show).

According to the present exemplary embodiment, in the optical compensator 173, the minor axis (i.e., the optic axis OA2) of the index ellipsoid RIE2 is inclined at a constant angle θ2 with respect to the optical path VP of the light flux perpendicularly incident to the liquid crystal layer 71. The inclination angle θ2 is substantially equal to the pre-tilt angle θ1 of the liquid crystal layer 71. Similarly to the first exemplary embodiment, the fact that the inclination angle θ2 of the minor axis of the index ellipsoid RIE2 in the optical compensator 173 is substantially equal to the pre-tilt angle θ1 of the liquid crystal layer 71 means that a slight difference is sometimes generated between both angles θ1 and θ2 in consideration with the difference of the refractive indices between the optical compensator 173 and the liquid crystal layer 71.

Similarly, according to the present exemplary embodiment, the integral value of the retardation Re′=f(η0, φ) can be minimized for various illumination devices by appropriately adjusting the inclination angle, the thickness d2, and the index ellipsoid RIE2 of the optical compensator 173 as described in the first exemplary embodiment. Therefore, the contrast of the image formed by the liquid crystal light valve 31 can be maximized.

### Third Exemplary Embodiment

Hereinafter, a liquid crystal light valve (e.g., an optical modulator) will be described as a liquid crystal device according to the third exemplary embodiment of the invention. The liquid crystal light valve according to the third exemplary embodiment is obtained by modifying the liquid crystal light valve according to the second exemplary embodiment. Therefore, like elements denote like numerals as the second exemplary embodiment if they are not particularly described, and their detailed description will be omitted.

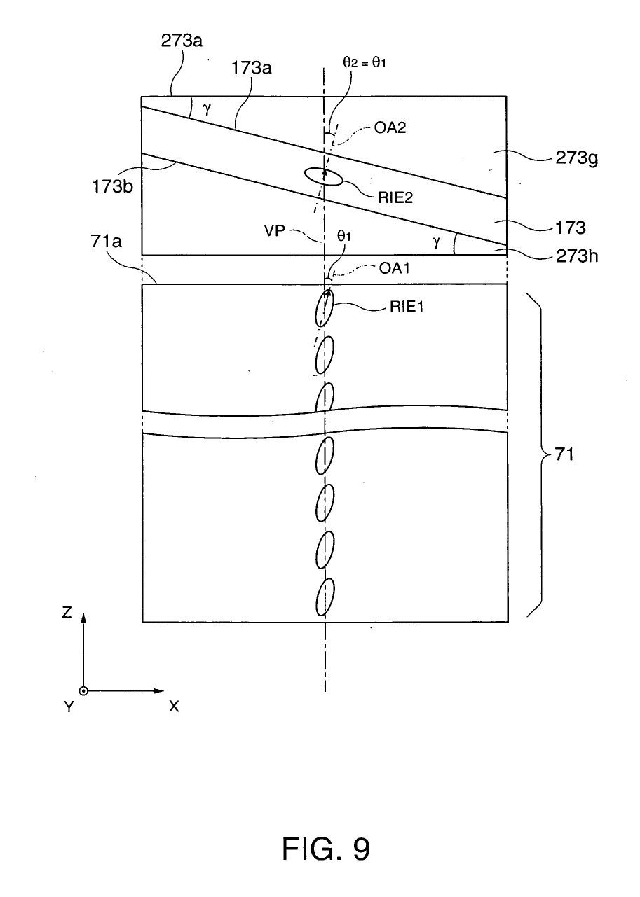

FIG. 9 is a side sectional view illustrating an optical compensation element 273 included in a liquid crystal light valve according to the third exemplary embodiment. Referring to FIG. 9, the optical compensation element 273 includes an optical compensator 173 fabricated to have an optic axis OA2 perpendicular to the incident flat surface 173a and the emitting flat surface 173b and a pair of prisms 273g and 273h having a wedge shape bonded to interpose the optical compensator 173. In this case, the prisms 273g and 273h having a wedge shape are isotropic plate members, and their refractive indices are substantially equal to that of the optical compensator 173. In addition, the wedge angle γ of both prisms 273g and 273h having the wedge shape is equal to the inclination angle θ2 of the minor axis of the index ellipsoid RIE2 of the optical compensation element 273. As a result, although the optical path VP of the light flux perpendicularly incident to the incident surface 71a of the liquid crystal layer 71 is perpendicularly incident to the incident surface 273a of the optical compensation element 273, the optical path VP is obliquely incident on the incident flat surface 173a of the optical compensator 173.

According to the present exemplary embodiment, in the optical compensator 173 of the optical compensation element 273, the optic axis OA2 of the index ellipsoid RIE2 is inclined at a constant angle θ2 with respect to the optical path VP of the light flux perpendicularly incident to the liquid crystal layer 71. The inclination angle θ2 is substantially equal to the pre-tilt angle θ1 of the liquid crystal layer 71. In this case, similarly to the first exemplary embodiment, the fact that the inclination angle θ2 of the minor axis of the refractive index RIE2 of the optical compensator 173 is substantially equal to the pre-tilt angle θ1 of the liquid crystal layer 71 means that a slight difference is sometimes generated between the angles θ1 and θ2 in consideration with the difference of refractive indices between the optical compensator 173 and the liquid crystal layer 71.

Similarly, according to the present exemplary embodiment, the integral value of the retardation Re′=f(η0, φ) can be minimized for various illumination devices by appropriately adjusting the inclination angle, the thickness d2, the index ellipsoid RIE2 and the like of the optical compensator 173 of the optical compensation element 273 as described in the first exemplary embodiment. Therefore, the contrast of the image formed by the liquid crystal light valve 31 can be maximized.

### Fourth Exemplary Embodiment

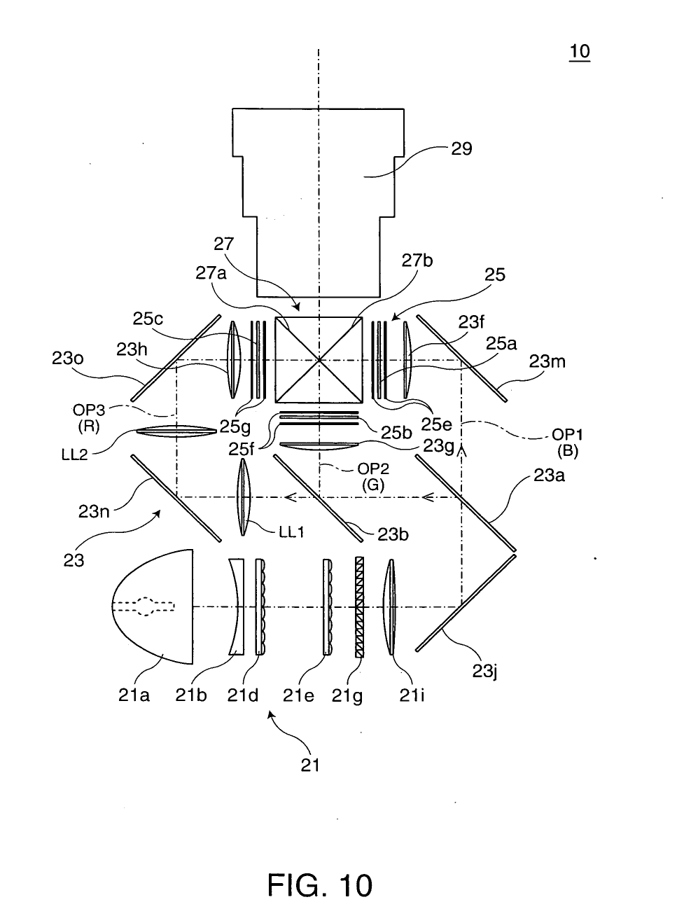

FIG. 10 is a view illustrating a structure of an optical system of a projector including the liquid crystal light valve 31 shown in FIG. 1.

A projector 10 includes a light source device 21 which generates a source light; a color separation optical system 23 which separates the light from the light sources from the light source device 21 into three colors including red, green, and blue; an optical modulator 25 illuminated by each colored illumination light emitted from the color separation optical system 23; a cross dichroic prism 27 which synthesizes the imaging light beams having respective colors from the optical modulator 25; and a projection lens 29 which is a projecting optical system for projecting the imaging light beams from the cross dichroic prism 27 onto a screen (not shown). The light source device 21, the color separation optical system 23, the optical modulator 25, and the cross dichroic prism 27 constitutes an image forming device for providing imaging light beams to be projected onto the screen.

In the projector 10, the light source device 21 includes a light source lamp 21a, a concave lens 21b, a pair of fly eye optical system 21d and 21e, a polarization converting member 21g, and a superposition lens 21i. The light source lamp 21a among them may be, for example, a high-pressure mercury vapor lamp, and have a concave mirror for collecting the light and emitting the source light to the front side. The concave lens 21b has a function of collimating the source light from the light source lamp 21a but may be omitted. The pair of fly eye optical system 21d and 21e includes a plurality of elementary lenses arranged in a matrix state. The elementary lenses divide the source light propagated from the light source lamp 21a through the concave lens 21b into individual light beams and collect and radiate the individual light beams. The polarization converting member 21g converts the source light emitted from the fly eye optical system 21e into only the S-polarized components perpendicular to the sheet surface of FIG. 10 and supplies them to the subsequent optical system. The superposition lens 21i entirely collects the illumination light passing through the polarization converting member 21g to allow the optical modulation units of each color in the optical modulator 25 to perform superposed illumination. That is, the illumination light passing through the pair of fly eye optical system 21d and 21e and the superposition lens 21i is propagated through the color separation optical system 23, which will be described below, and uniformly illuminates the liquid crystal panels 25a, 25b, and 25c which are provided in the optical modulator 25 and have a respective color, in a superposed manner.

The color separation optical system 23 includes first and second dichroic mirrors 23a and 23b; three field lenses 23f, 23g, and 23h corresponding to a corrective optical system; and reflective mirrors 23j, 23m, 23n, and 23o, and constitutes an illumination device together with the light source device 21. The first dichroic mirror 23a reflects, for example, the red and green light and transmits only the blue light out of three colors including red, green, and blue. In addition, the second dichroic mirror 23b reflects, for example, the green light and transmits only the red light out of two incident colors including red and green. In the color separation optical system 23, the optical path of the substantively white source light from the light source device 21 is bended by the reflection mirror 23j and incident on the first dichroic mirror 23a. The S-polarized blue light passing through the first dichroic mirror 23a is incident on the field lens 23f via the reflection mirror 23m. In addition, the S-polarized green light reflected on the first dichroic mirror 23a and further reflected by the second dichroic mirror 23b is incident on the field lens 23g. Furthermore, the S-polarized red light passing through the second dichroic mirror 23b passes through the lenses LL1 and LL2 and the reflection mirrors 23n and 23o and then is incident on the field lens 23h for adjusting the incident angle. The lenses LL1 and LL2 and the field lens 23h constitute a relay optical system. The relay optical system has a function of almost directly transmitting the image of the first lens LL1 to the field lens 23h through the second lens LL2.

The optical modulator 25 includes three liquid crystal panels 25a, 25b and 25c and three polarization filter sets 25e, 25f and 25g interposing three liquid crystal panels 25a, 25b and 25c, respectively. In this case, the liquid crystal panel 25a for the blue light and a pair of polarization filters 25e and 25e interposing the liquid crystal panel 25a constitutes a blue liquid crystal light valve, which modulates luminance of the blue light of the imaging light beams obtained after the luminance modulation in a two-dimensional manner on the basis of image information. The blue liquid crystal light valve has a structure similar to the liquid crystal light valve 31 shown in FIG. 1, and includes an optical compensation element OC for improving the contrast. Similarly, the liquid crystal panel 25b for the green light and corresponding polarization filters 25f and 25f thereof constitute a green liquid crystal light valve. Similarly, the liquid crystal panel 25c for the red light and the polarization filters 25g and 25g constitute a red liquid crystal light valve. The green and red liquid crystal light valves have the structure similar to that of the liquid crystal light valve 31 shown in FIG. 1. Specifically, the polarization filters 25e, 25f, and 25g correspond to the polarization filters 31b and 31c, and the liquid crystal panels 25a, 25b, and 25c correspond to the liquid crystal device 31a of FIG. 1. They have an optical compensation element OC, i.e., an optical compensator 73, in order to improve the contrast.

The blue light divided by transmitting through the first dichroic mirror 23a of the color separation optical system 23 is incident on the first liquid crystal panel 25a for the blue light through the field lens 23f. The green light divided by reflecting on the second dichroic mirror 23b of the color separation optical system 23 is incident on the second liquid crystal panel 25b for the green light through the field lens 23g. The red light divided by transmitting through the second dichroic mirror 23b is incident on the third liquid crystal panel 25c for the red light through the field lens 23h. Each liquid crystal panel 25a to 25c is a non-luminescent type optical modulator which modulates spatial intensity distribution of the incident illumination light. The three-color light incident on the liquid crystal panels 25a to 25c, respectively, is modulated by a drive signal or an image signal input to the liquid crystal panels 25a to 25c as an electrical signal. In this case, the polarization filters 25e, 25f, and 25g adjust the polarization direction of the illumination light incident on the liquid crystal panels 25a to 25c, respectively, as well as extract light components having a predetermined polarization direction from the modulated light emitted from each liquid crystal panel 25a to 25c as an imaging light beams.

The cross dichroic prism 27 is an optical synthesizing member, and has a square shape in a plan view when four rectangular prisms are bonded. A pair of dielectric multilayer films 27a and 27b crossed in an X-shape is provided on the interface where the rectangular prisms are bonded. The first dielectric multilayer film 27a reflects the blue light and the other second dielectric multilayer film 27b reflects the red light. The cross dichroic prism 27 reflects the blue light from the liquid crystal panel 25a by the first dielectric multilayer film 27a to output it to the right side of the advancing direction, lets the green light from the liquid crystal panel 25b pass through the first and second dielectric multilayer films 27a and 27b, and reflects the red light from the liquid crystal panel 25c by the second dielectric multilayer film 27b to output it to the left side of the advancing direction.

The projection lens 29 projects the colored imaging light beams synthesized by the cross dichroic prism 27 onto a screen (not shown) with a desired magnification rate. That is, a color moving picture or a color still image corresponding to the drive signal or the image signal input to each liquid crystal panel 25a to 25c is projected onto the screen with a desired magnification rate.

### Fifth Exemplary Embodiment

Hereinafter, a liquid crystal light valve (an optical modulator) which is a liquid crystal device according to a fifth exemplary embodiment of the present invention will be described. Since the liquid crystal light valve according to a fifth exemplary embodiment is made by modifying the liquid crystal light valve according to a first exemplary embodiment, like reference numerals denote like elements as in the first exemplary embodiment if they are not particularly mentioned.

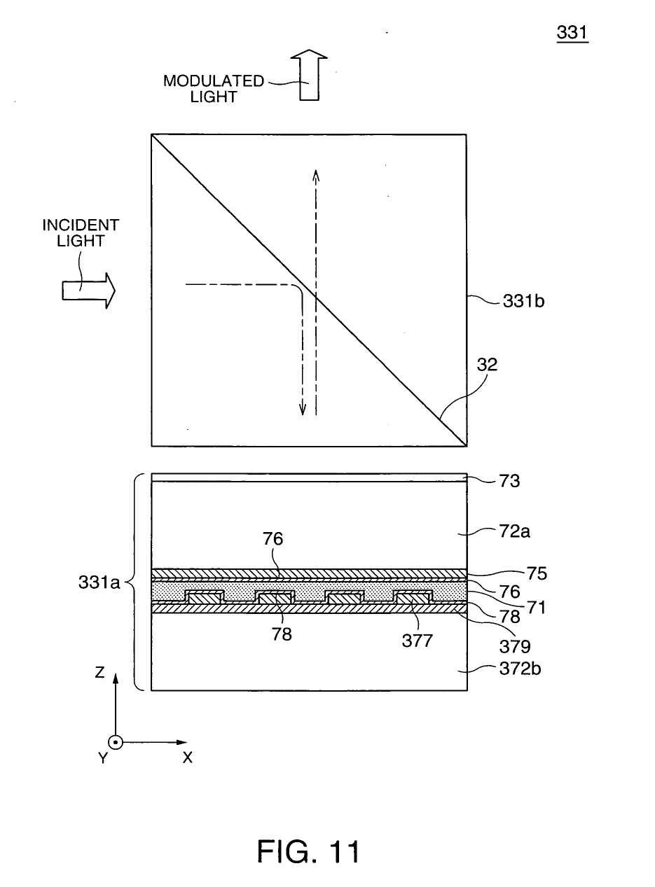

FIG. 11 is an enlarged side sectional view illustrating a liquid crystal light valve structure according to a fifth exemplary embodiment. The liquid crystal light valve 331 includes a liquid crystal device 331a and a polarization beam splitter 331b. The liquid crystal device 331a is a reflection liquid crystal panel which changes the polarization direction of the incident light on a pixel basis depending on an input signal.

The liquid crystal device 331a includes a first substrate 72a disposed in a viewer side, a second substrate 372b disposed in the opposite side, and a liquid crystal layer 71 which is interposed therebetween and formed of liquid crystals operated in a vertical alignment mode (i.e., a vertical alignment type liquid crystals). In addition, the liquid crystal device 331a is similar to that of the first exemplary embodiment, except that there is no black matrix in the first substrate 72a located in a viewer side or its circumference.

A plurality of reflection pixel electrodes 377 arranged in a matrix state are formed in the liquid crystal layer 71 side of the second substrate 372b with a circuit layer 379 being interposed therebetween. Thin film transistors (not shown) provided in the circuit layer 379 are electrically connected to each reflection pixel electrode 377. An orientation film 78 is formed on the circuit layer 379 and the reflection pixel electrode 377. The first and second substrates 72a and 372b, the liquid crystal layer 71 interposed therebetween, and the electrodes 75 and 377 constitute a liquid crystal cell for changing the polarization state of the incident light. Each pixel included in the liquid crystal cell has a pixel electrode 377, a common electrode 75, and a liquid crystal layer 71 interposed therebetween.

In the liquid crystal light valve 331, the polarization beam splitter 331b is provided in place of the polarization filters 31b and 31c in order to adjust the polarization direction of the light incident on the liquid crystal device 331a and the polarization direction of the light emitted from the liquid crystal device 331a. The polarization beam splitter 331b is provided therein with a polarization splitting film 32 for splitting the polarization.

The polarization beam splitter 331b reflects S-polarized light of the incident light by the polarization splitting film 32 so as to enter the reflected light on the liquid crystal device 331a, and transmits P-polarized light which passing through the polarization splitting film 32 out of the modulated light emitted from the liquid crystal device 331a. In other words, in an off-state in which no voltage is applied to the liquid crystal layer 71, since S-polarized light is emitted from the liquid crystal device 331a, and reflected by the polarization splitting film 32 of the polarization beam splitter 331b, it is possible to obtain a maximum light-shielding condition (a minimum luminance condition) in imaging light. In an on-state in which voltage is applied to the liquid crystal layer 71, since P-polarized light is emitted from the liquid crystal device 331a, and passes through the polarization splitting film 32 of the polarization beam splitter 331b, it is possible to obtain a maximum transmitting condition (a maximum luminance condition). In addition, the polarization beam splitter 331b can be replaced with a reflection type polarization splitting element such as a wire-grid polarizer obliquely arranged to an optical axis of a system.

In the liquid crystal device 331a, an optical compensator 73 having a thickness ranged between, for example, 1 and 200 μm is attached to an incident surface of the first substrate 72a, i.e., a flat surface facing the polarization beam splitter 331b. It should be noted that the optical compensator 73 functions as an optical compensation element by itself, and is attached to the flat surface of the first substrate 72a using an optical adhesive. In addition, the optical compensator 73 is similar to that illustrated in association with the first exemplary embodiment. In other words, the optical compensator 73 is a flat element formed of light-transmissive negative uniaxial compounds, and its optic axis is located on an XZ plane including the orientation direction (i.e., an X-direction) of the liquid crystal layer 71 and has a predetermined inclination angle with respect to the Z-axis.

The functions of the optical compensator 73 are similar to those of the first exemplary embodiment, except that the incident light beams travels back and forth between the optical compensator 73 and the liquid crystal layer 71. In other words, a total retardation RE for the vertically incident light in the liquid crystal device 331a is given by an absolute value of a difference between a doubled Re1 given in Equation (3) described above and a doubled Re2 given in Equation (6). If Re1=Re2, the light reflected by the polarization beam splitter 331b and incident on the liquid crystal device 331a and the light reflected by the liquid crystal device 331a and incident on the polarization beam splitter 331b have the same polarization. Therefore, the light-shielding for the vertically incident light becomes perfect, and the contrast of the image determined by the light-shielding and the transmission in the liquid crystal light valve 331 becomes maximum.

Similarly, it is possible to minimize an integral value of the retardation Re′=f(η0, φ) for various illumination devices having W(η0, φ) by adjusting the thickness d2 or the index ellipsoids RIE2 in the optical compensator 73. Therefore, it is possible to maximize the contrast of an image formed by the liquid crystal light valve 331.

In the fifth exemplary embodiment, although the optical compensator 73 is a flat plate attached to the first substrate 72a in parallel, it may be inclined to the first substrate 72a as in the second exemplary embodiment, or it may be inclined to the first substrate 72a as well as locked using prisms having a wedge shape as in the third exemplary embodiment.

### Sixth Exemplary Embodiment

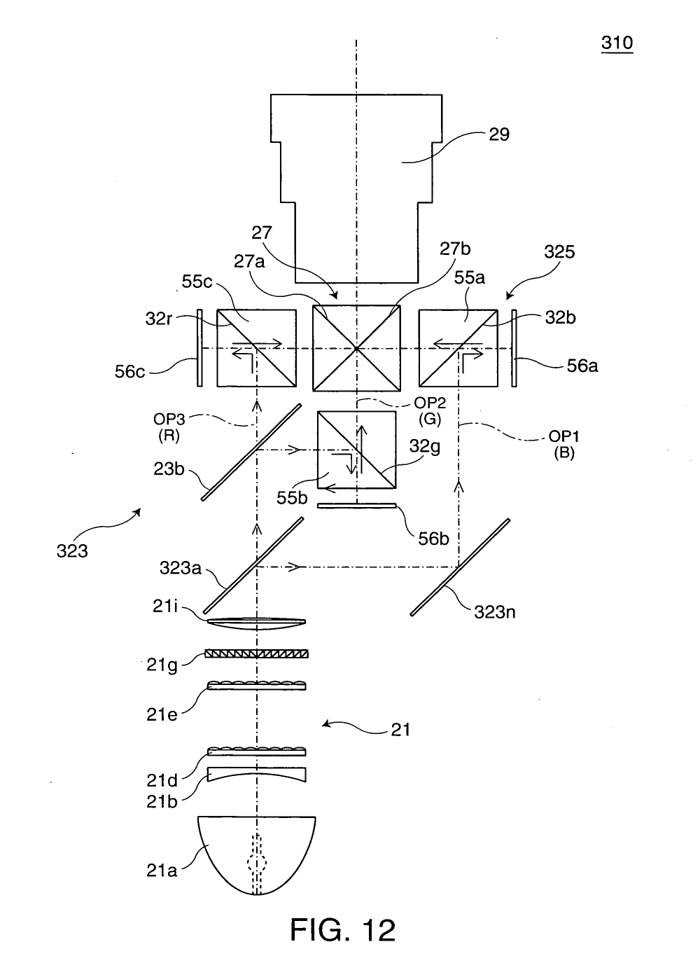

FIG. 12 is a diagram illustrating an optical system of a projector including the liquid crystal light valve 331 shown in FIG. 11. The projector 310 according to a sixth exemplary embodiment is formed by modifying the projector 10 of the fourth exemplary embodiment, where like reference numerals denote like elements, if they are not particularly specified.

The projector 10 according to the present invention includes: a light source device 21 which generates source light; a color separation optical system 323 which separates the light from the light source device 21 into three colors including red, green, and blue; an optical modulator 325 illuminated by each colored illumination light emitted from the color separation optical system 323; a cross dichroic prism 27 which synthesizes the imaging light beams having respective colors from the optical modulator 325; and a projection lens 29 which is a projecting optical system for projecting the imaging light beams from the cross dichroic prism 27 onto a screen (not shown).

The color separation optical system 323 includes first and second dichroic mirrors 323a and 23b and a reflective mirror 323n. In this color separation optical system 23, the substantively white source light from the light source device 21 is incident on the dichroic mirror 323a. For example, the S-polarized blue light reflected by the second dichroic mirror 323a is incident on the polarization beam splitter 55a. In addition, the S-polarized green light passing through the first dichroic mirror 323a and reflected by the second dichroic mirror 23b is incident on the polarization beam splitter 55b. In addition, the S-polarized red light passing through the second dichroic mirror 23b is incident on the polarization beam splitter 55c.

The optimal modulator 325 includes three polarization beam splitters 55a, 55b, and 55c and three liquid crystal panels 56a, 56b, and 56c. It should be noted that the polarization beam splitter 55a for the blue light and the liquid crystal panel 56b constitutes a blue light liquid crystal light valve for 2-dimensionally modulating the luminance of the blue light out of the imaging light obtained after the luminance modulation on the basis of the image information. The blue liquid crystal light valve has the same construction as that of the liquid crystal light valve 331 shown in FIG. 11. Similarly, the green light polarization beam splitter 55b and the liquid crystal panel 56b also constitute a green light liquid crystal light valve, and the red light polarization beam splitter 55c and the liquid crystal panel 56c also constitute a red light liquid crystal light valve. In addition, the green and red light liquid crystal light valves have the same construction as that of the liquid crystal light valve 331 shown in FIG. 11. Specifically, the polarization beam splitter 55a, 55b, and 55c correspond to the polarization beam splitter 331b of FIG. 11, and have polarization separation films 32b, 32g, and 32r, respectively. Furthermore, the liquid crystal panels 56a, 56b, and 56c correspond to the liquid crystal device 331a of FIG. 11, and include an optical compensation element, i.e., the optical compensator 73 for improving the contrast.

Although the exemplary embodiments of the invention have been described, the invention is not limited to the exemplary embodiments, but may be modified in various forms without departing from the scope of the appended claims, the detailed description, and the accompanying drawings of the invention. For example, the invention may be modified as follows.

That is, although sapphire is used in the optical compensator 73 in the aforementioned exemplary embodiments, other negative uniaxial crystals may be used instead of sapphire. Furthermore, the optical compensator 73 may be substituted with a stretched film. While the optic axis of the stretched film is typically perpendicular to the incident surface, the integral value of the retardation for each light flux during the off state, in which no voltage is applied to the liquid crystal cell, of the liquid crystal light valve 31 can be minimized by setting the stretched film as the optical compensator 173 as shown in FIGS. 7 and 8. Therefore, the contrast of the image formed by the liquid crystal light valve 31 can be maximized. The stretched film is suitable for mass production. In addition, the index ellipsoid of the stretched film generally has a relationship of nx>ny>nz, where nx, ny, and nz denote the respective axis according to the refractive index of the stretched film, and d2 denotes a thickness of the stretched film. Therefore, parameters Re and Rth corresponding to the typical characteristic of the stretched film are obtained as follows:

Re=(nx−ny)·d2 (12)

Rth={(nx+ny)/2−nz}·d2 (13)

where Re denotes a refractive index difference in the major axis of the ellipsoid, and is preferably 0 nm. In addition, Rth denotes a difference between diameters of the minor axes of the ellipsoid, for example it is 384 nm. Even when the refractive index difference Re is not 0 nm, the same function can be obtained by approximation. Therefore, a stretched film of which the refractive index difference Re is not 0 nm may be set in the liquid crystal light valve 31. When the refractive index difference Re is not 0 nm, the characteristic of the refractive index in an axis direction perpendicular to the incident surface 71a of the liquid crystal layer 71 can be changed by rotating the optical compensator 173 around the axis perpendicular to the incident flat surface 173a. Therefore, the contrast can be adjusted or improved.

Although the optical compensator 73 is disposed in the incident side of the liquid crystal layer 71 in the aforementioned exemplary embodiments, the optical compensator 73 may be disposed in the emitting side of the liquid crystal layer 71 (i.e., front and rear sides of the emitting side cover 74b). In addition, when the first substrate 72a or the like has a condensing micro-lens, the optical compensator 73 is preferably disposed in the side opposite to the first substrate 72a in order not to significantly change an angle of the light flux between the optical compensator 73 and the liquid crystal layer 71. In addition, although the fifth and sixth exemplary embodiments exemplify only the case where the S-polarized light reflected by the polarization separation element of the polarization beam splitter is incident on the liquid crystal device, and the P-polarized light passing through the polarization separation element of the polarization beam splitter is emitted as the imaging light, the P-polarized light passing through the polarization separation element of the polarization beam splitter may be incident on the liquid crystal device, and the S-polarized light reflected by the polarization separation element of the polarization beam splitter may be emitted as the imaging light.

Although the light source device 21 of the projector 10 includes a light source lamp 21a, a pair of fly eye optical system 21d and 21e, the polarization converting member 21g, and a superposition lens 211 in the aforementioned exemplary embodiments, the fly eye optical system 21d and 21e, the polarization converting member 21g and the like may be omitted, and the light source lamp 21a may be substituted with other light sources such as LEDs.

Although the color separation is performed for the illumination light using the color separation optical system 23, the modulation for each color is performed in the optical modulator 25, and then the image of each color is synthesized by the cross dichroic prism 27 in the aforementioned exemplary embodiments, the image may be formed by a single liquid crystal panel (i.e., the liquid crystal light valve 31).

Although the projector 10 uses three liquid crystal panels 25a to 25c in the aforementioned exemplary embodiments, the invention may be applied to a projector which uses a single liquid crystal panel, a pair of liquid crystal panels, or four or more liquid crystal panels.

Although a front type projector which projects an image onto the screen from the viewer side is exemplified in the aforementioned exemplary embodiments, the invention may be applied to a rear type projector which projects an image onto the screen from the opposite side of the viewer.

What is claimed is:

1. A liquid crystal device comprising:
a liquid crystal cell that includes liquid crystals operating in a vertical alignment mode, optical axes of the liquid crystals are inclined and oriented at a predetermined pre-tilt angle with respect to a normal line to an incident surface in an off-state in which no voltage is applied to the liquid crystal cell; and
an optical compensator having an optic axis in a direction inclined with respect to the incident surface as an orientation direction of the liquid crystals in an off-state.

2. The liquid crystal device according to claim 1,
wherein the optic axis of the optical compensator is inclined at a predetermined angle corresponding to the predetermined pre-tilt angle of the liquid crystals of the liquid crystal cell in an off-state with respect to an optical path of a light beam incident in a normal direction to the incident surface of the liquid crystal cell.

3. The liquid crystal device according to claim 2,
wherein the optical compensator include a flat element having an incident flat surface and an emitting flat surface paralleled with the incident surface of the liquid crystal cell, the panel element have an optic axis inclined with respect to a normal line of the incident flat surface and the emitting flat surface.

4. The liquid crystal device according to claim 2,
wherein the optical compensator include a flat element having an incident flat surface and an emitting flat surface paralleled with each other and has an optical axis paralleled with a normal line of the incident flat surface and the emitting flat surface, the incident flat surface and the emitting flat surface are inclined with respect to the incident surface of the liquid crystal cell.

5. The liquid crystal device according to claim 4,
wherein the optical compensator further has a pair of light-transmissive isotropic-members, each one of the isotropic-members has a predetermined wedge angles, and the isotropic-members provide an incident flat surface and an emitting flat surface paralleled with the incident surface of the liquid crystal cell by interposing the flat element therebetween.

6. The liquid crystal device according to claim 1,
wherein the optical compensator has a thickness capable of substantially compensating for a retardation generated in the liquid crystals in an off-state.

7. The liquid crystal device according to claim 1,
wherein the optical compensator is formed of negative uniaxial crystals.

8. The liquid crystal device according to claim 1,
wherein the optical compensator has a thickness capable of substantially compensating for a retardation generated in the liquid crystals in an off-state according to a range of inclination angle of illumination light with respect to the incident surface of the liquid crystal cell.

9. A projector comprising:
an optical modulator including the liquid crystal device according to claim 1;
an illumination device that illuminates the optical modulator; and
a projection lens that projects an image formed by the optical modulator.

10. The projector according to claim 9,
wherein the liquid crystal device is a transmitting type, and the optical modulator has a pair of polarization elements arranged to interpose the liquid crystal cell and the optical compensation element.

11. The projector according to claim 9,
wherein the liquid crystal device is a reflective type, the optical modulator has a polarization beam splitter, and the optical compensation element is interposed between the liquid crystal cell and the polarization beam splitter.

12. The projector according to 11,
wherein the optic axis of the optical compensator is inclined at a predetermined angle corresponding to the predetermined pre-tilt angle of the liquid crystals of the liquid crystal cell in an off-state with respect to an optical path of a light beam incident in a normal direction to the incident surface of the liquid crystal cell.

13. The projector according to 12,
wherein the optical compensator is a flat element having an incident flat surface and an emitting flat surface paralleled with the incident surface of the liquid crystal cell, and an optic axis inclined with respect to a normal line of the incident flat surface and the emitting flat surface.

14. The projector according to 12,
wherein the optical compensator is a flat element having an incident flat surface and an emitting flat surface paralleled with each other and has an optical axis paralleled with a normal line of the incident flat surface and the emitting flat surface, the flat incident flat surface and the emitting flat surface are inclined with respect to the incident surface of the liquid crystal cell.

15. The projector according to 14,
wherein the optical compensator further has a pair of light-transmissive isotropic-members, each one of the isotropic-members has a predetermined wedge angles, and the isotropic-members provide an incident flat surface and an emitting flat surface paralleled with the incident surface of the liquid crystal cell by interposing the flat element therebetween.

16. The projector according to 15,
wherein the optical compensator has a thickness capable of substantially compensating for a retardation generated in the liquid crystals in an off-state.

17. The projector according to 16,
wherein the optical compensator is formed of negative uniaxial crystals.

18. The projector according to 17,
wherein the optical compensator has a thickness capable of substantially compensating for a retardation generated in the liquid crystals in an off-state according to an inclination angle of illumination light with respect to the incident surface of the liquid crystal cell.
